(19) United States
(12) Patent Application Publication
(10) Pub. No.: US 2012/0134075 A1
(43) Pub. Date: May 31, 2012

(54) ELECTROCHEMICAL DEVICE

(75) Inventor: Yuki KAWAI, Takasaki-shi (JP)

(73) Assignee: TAIYO YUDEN CO., LTD., Tokyo (JP)

(21) Appl. No.: 13/287,442

(22) Filed: Nov. 2, 2011

(30) Foreign Application Priority Data
Nov. 26, 2010 (JP) 2010-264216

(51) Int. Cl. H01G 9/042

(52) U.S. Cl. 361/532

(57) ABSTRACT

In an exemplified lithium ion capacitor, a negative electrode 20 has a first layer 21 and a second layer 22, the first layer 21 and second layer 22 are laminated to each other, and a lithium metal sheet 60 is placed between the first layer 21 and second layer 22, and accordingly one side of the lithium metal sheet 60 in the thickness direction contacts the first layer 21, while the other side in the thickness direction contacts the second layer 22. Since lithium in the lithium metal sheet 60 is easily doped by an active material near a contact part, the fact that both sides of the lithium metal sheet 60 in the thickness direction contact an active material allows for efficient pre-doping and consequent improvement of productivity.

### BACKGROUND

1. Field of the Invention

The present invention relates to an electrochemical device, comprising: an electricity storage element formed by a positive electrode, a separator and a negative electrode laminated to each other; an electrolyte; a case having a concaved section in which to accommodate the electricity storage element; and a lid that closes the concaved section of the case and thereby seals the electricity storage element and electrolyte in the case, wherein the negative electrode is pre-doped with lithium ions.

2. Description of the Related Art

Repeatedly chargeable/dischargeable electrochemical devices of various structures, shapes and sizes are proposed in recent years. They include lithium ion secondary cells of rocking chair type, where the positive electrode is made of lithium-containing metal oxide and the negative electrode active material uses graphite or graphitizable carbon material capable of occluding and desorbing lithium ions, so that lithium ions are supplied from the positive electrode to the negative electrode when the cell is charged and lithium ions return from the negative electrode to the positive electrode when the cell is discharged (refer to Patent Literature 1, for example). These lithium ion secondary cells have a relatively short cycle life because the lithium-containing metal oxide constituting the positive electrode and graphite or graphitizable carbon material constituting the negative electrode expand as they occlude lithium ions, and shrink as they release lithium ions. Also, the plane spacing of graphite or graphitizable carbon material constituting the negative electrode is small relative to the size of the lithium ion and therefore the negative electrode cannot occlude or desorb lithium ions quickly enough when the cell is charged or discharged rapidly, which is not ideal from the viewpoints of improvement of energy density and prevention of dendrite precipitation.

To improve the above points, cells using polyacene (PAS) for the negative electrode active material have been developed (refer to Patent Literature 1, for example). However, polyacene has poor charge/discharge efficiency compared to graphite or graphitizable carbon material. Accordingly, lithium metal is placed near the negative electrode when the electricity storage element and electrolyte are sealed in the case, and lithium ions that have dissolved from this lithium metal into the electrolyte are caused to be stored in the negative electrode active material before charging (this action is hereinafter also referred to as “pre-doping”), in order to increase the capacity of a lithium ion secondary cell that uses polyacene for the negative electrode active material.

On the other hand, electric dual layer capacitors offering a longer cycle life and better output characteristics than lithium ion secondary cells are also drawing attention in recent years. Electric dual layer capacitors can achieve greater energy density by improving the specific surface areas of active materials constituting the positive electrode and negative electrode and also by improving the charge voltage. However, the charge voltage achieved by an electric dual layer capacitor is limited on the upper side because, even if non-aqueous electrolyte is used for the electric dual layer capacitor, setting the charge voltage to 3 V or above will cause the non-aqueous solvent in non-aqueous electrolyte to undergo oxidative decomposition.

In view of the above, lithium ion capacitors have been developed where polyacene, natural graphite, artificial graphite, coke, non-graphitizable carbon material, graphitizable carbon material, etc., is used for the negative electrode active material, while lithium metal is placed near the negative electrode when the electricity storage element and electrolyte are sealed in the battery case, so that the negative electrode active material is pre-doped with lithium ions that have dissolved from this lithium metal into the electrolyte (refer to Patent Literature 1, for example). To improve the energy density of these lithium ion capacitors, lithium ions are caused to be stored in the negative electrode active material before charging so that the electrical potential of the negative electrode remains lower than the electrical potential of the positive electrode before charging, which has the effect of increasing the charge voltage.

Here, the negative electrode active material of a lithium ion capacitor also occludes and releases lithium ions just like that of a lithium ion secondary cell. For this reason, graphite or graphitizable carbon material is ideal for the active material to achieve a high negative electrode capacity. However, graphite or graphitizable carbon material expands as it occludes lithium ions and shrinks as it releases lithium ions, which results in a relatively short cycle life. Also, the plane spacing of graphite or graphitizable carbon material constituting the negative electrode is small relative to the size of the lithium ion and therefore the negative electrode cannot occlude or desorb lithium ions quickly enough when the cell is charged or discharged rapidly, which is not ideal from the viewpoints of improvement of energy density and prevention of dendrite precipitation.

On the other hand, use of non-graphitizable carbon material for the active material results in less expansion and shrinking of the material as it occludes and releases lithium ions because the plane spacing of such material is greater than that of graphite or graphitizable carbon material, which helps achieve a longer cycle life compared to when graphite or graphitizable carbon material is used. However, non-graphitizable carbon material tends to have lower lithium charge density compared to graphite or graphitizable carbon material, and is also more vulnerable to change in discharge potential compared to graphite or graphitizable carbon material.

In view of the above, attempts have been made to mix graphite powder with non-graphitizable carbon material powder and further mix this powder mixture with binder or auxiliary conductant to form a negative electrode, for the purpose of utilizing the aforementioned benefits of both graphite and non-graphitizable carbon material (refer to Patent Literature 2, for example).

Various types of electric dual layer capacitors and lithium ion capacitors are available. For example, film-package type capacitors where laminate film is used to seal the electricity storage element and electrolyte (refer to Patent Literature 3, for example), metal-can type capacitors where a metal can is used to seal the electricity storage element and electrolyte (refer to Patent Literature 4, for example), and coin or button type capacitors having a case with a concaved section in which to accommodate the electricity storage element and a lid that closes the concaved section of the case and thereby seals the electricity storage element and electrolyte in the case, with the positive electrode or negative electrode of the electricity storage element contacting one side of the lid in the thickness direction (refer to Patent Literature 5, for example), are known.

Here, lithium ion capacitors and lithium ion secondary cells of coin or button type are designed in such a way that one side of the electricity storage element in the laminated direction contacts the bottom of the concaved section of the case, while the other side of the electricity storage element in the laminated direction contacts one side of the lid in the thickness direction, and the electricity storage element is sandwiched between the bottom of the concaved section of the case and one side of the lid in the thickness direction. Also, the electricity storage element is around 1 to 2 mm thick in many cases, and the thickness of the separator between the positive electrode and negative electrode is mostly around several hundred μm. For this reason, use of graphite or graphitizable carbon material for the negative electrode active material of a lithium ion capacitor or lithium ion secondary cell of coin or button type may cause significant expansion or shrinking of the material as it occludes or releases lithium ions, as mentioned above, and therefore non-graphitizable carbon material is deemed more suitable for the negative electrode active material than graphite or graphitizable carbon material.

In addition, a lithium ion capacitor having an electricity storage element formed by a positive electrode, a separator and a negative electrode laminated to each other is such that when the electricity storage element and electrolyte are sealed in the case, a lithium metal sheet for pre-doping is attached on one side of the electricity storage element in the thickness direction (refer to Patent Literature 6, for example). Here, ideally this one side of the electricity storage element in the thickness direction constitutes the negative electrode and the lithium metal sheet makes direct contact with the negative electrode active material, because it shortens the time required for pre-doping and improves productivity. Also, because non-graphitizable carbon material has a greater plane spacing than graphite or graphitizable carbon material, non-graphitizable carbon material is deemed more suitable than graphite or graphitizable carbon material in terms of shorter pre-doping time.

### PATENT ART LITERATURES

[Patent Literature 1] International Patent Application Publication No. WO2003/003395,
[Patent Literature 2] Japanese Patent Laid-open No. 2009-070598
[Patent Literature 3] Japanese Patent Laid-open No. 2009-267026
[Patent Literature 4] Japanese Patent Laid-open No. Hei 07-192724
[Patent Literature 5] Japanese Patent Laid-open No. 2007-221008
[Patent Literature 6] Japanese Patent Laid-open No. 2006-286919

### SUMMARY

### Problems to Be Solved by the Invention

An object of the present invention is to provide an electrochemical device that can improve productivity and cycle characteristics and also reduce resistance.

### Means for Solving the Problems

To achieve the aforementioned object of the electrochemical device proposed by the present invention, an electrochemical device is provided, comprising: an electricity storage element formed by a positive electrode, a separator and a negative electrode laminated to each other in a specified direction; a case having a concaved section in which to accommodate the electricity storage element; and a lid that closes the concaved section of the case and thereby seals the electricity storage element and electrolyte in the case; wherein one side of the electricity storage element in the laminated direction contacts one side of the lid in the thickness direction; and wherein the aforementioned negative electrode has a first layer containing non-graphitizable carbon material as an active material, and a second layer containing graphite and/or graphitizable carbon material as an active material, where the second layer contains at least 90 percent by weight of graphite or graphitizable carbon material relative to all its active material, and the first layer and second layer are laminated to each other in the aforementioned specified direction with a lithium metal sheet placed in between.

The present invention also provides an electrochemical device, comprising: an electricity storage element formed by a positive electrode, a separator and a negative electrode laminated to each other in a specified direction; a case having a concaved section in which to accommodate the electricity storage element; and a lid that closes the concaved section of the case and thereby seals the electricity storage element and electrolyte in the case; wherein one side of the electricity storage element in the laminated direction contacts one side of the lid in the thickness direction, while the other side of the electricity storage element in the laminated direction contacts the bottom of the concaved section of the case; and wherein the aforementioned negative electrode has a first layer containing non-graphitizable carbon material as an active material, and a second layer containing graphite and/or graphitizable carbon material as an active material, where the second layer contains at least 90 percent by weight of graphite or graphitizable carbon material relative to all its active material, and the first layer and second layer are laminated to each other in the aforementioned specified direction with evidence of presence of a lithium metal sheet between the first layer and second layer.

Since the negative electrode is composed of the first layer and second layer, and the first layer and second layer are laminated and a lithium metal sheet is placed between the first layer and second layer, as explained above, one side of the lithium metal sheet in the thickness direction contacts the first layer of the negative electrode, while the other side in the thickness direction contacts the second layer of the negative electrode. Lithium in the lithium metal sheet is easily occluded by an active material near a contact part (this action is hereinafter also referred to as “doping”), so the fact that both sides of the lithium metal sheet contact an active material allows for efficient pre-doping and consequent improvement of productivity.

Also because the first layer contains non-graphitizable carbon material as an active material, while the second layer contains graphite or graphitizable carbon material as an active material, and the second layer contains at least 90 percent by weight of graphite or graphitizable carbon material relative to all its active material, the thickness dimension of the second layer increases as lithium ions are occluded in the second layer. Here, since one side of the electricity storage element in the laminated direction contacts one side of the lid in the thickness direction, while the other side of the electricity storage element in the laminated direction contacts the bottom of the concaved section of the case, the contact pressure between the electricity storage element and lid and the contact pressure between the electricity storage element and bottom of the concaved section of the case increase by the increase in the thickness dimension of the second layer. Assume, for example, that one side of the electricity storage element in the thickness direction constitutes the negative electrode or positive electrode, while the lid is made of conductive material and also constitutes one electrode of the electrochemical device. In this case, the internal resistance of the electrochemical device decreases as the contact pressure between the lid and one side of the electricity storage element in the thickness direction increases by the increase in the thickness dimension of the second layer. The inventor was able to discover, by experience, such decrease in internal resistance according to increase in contact pressure.

In addition, the first layer contains non-graphitizable carbon material as an active material, while the second layer contains at least 90 percent by weight of graphite or graphitizable carbon material relative to all its active material. Since non-graphitizable carbon material can occlude and release lithium ions at higher efficiency than graphite or graphitizable carbon material, lithium ions are occluded and released into/from the first layer more than into/from the second layer during charge and discharge. This makes it possible to support higher output and also suppress deterioration caused by repeated occlusion and release of lithium ions into/from the graphite or graphitizable carbon material constituting the second layer, which consequently leads to improved cycle characteristics.

### EFFECTS OF THE INVENTION

As explained above, the electrochemical device proposed by the present invention can improve productivity and cycle characteristics and also reduce resistance.

The aforementioned and other purposes of the present invention, as well as its constitution/characteristics and operation/effects, are made clear by the explanations provided below and drawings attached hereto.

### BRIEF DESCRIPTION OF THE DRAWINGS

FIG. 1 is a section view of an electrochemical device conforming to one embodiment of the present invention.

FIG. 2 is a section view of the electrochemical device before a lid is installed to a case.

FIG. 3 is a section view of the electrochemical device before a case is clinched.

FIG. 4 is a section view of an electrochemical device representing an example of variation of this embodiment.

### DESCRIPTION OF THE SYMBOLS

10 - - - Positive electrode
20 - - - Negative electrode
21 - - - First layer
22 - - - Second layer
30 - - - Separator
40 - - - Case
40a- - - Concaved section
40b- - - Side wall
40c- - - Gasket
40d- - - Bottom
50 - - - Lid
60 - - - Lithium metal sheet
70 - - - Ceramic case
70a- - - Concaved section
70b- - - Bottom
70c- - - Electrode sheet
70d- - - External electrode
80 - - - Lid

### MODE FOR CARRYING OUT THE INVENTION

Modes for carrying out the invention are explained below by referring to the drawings.

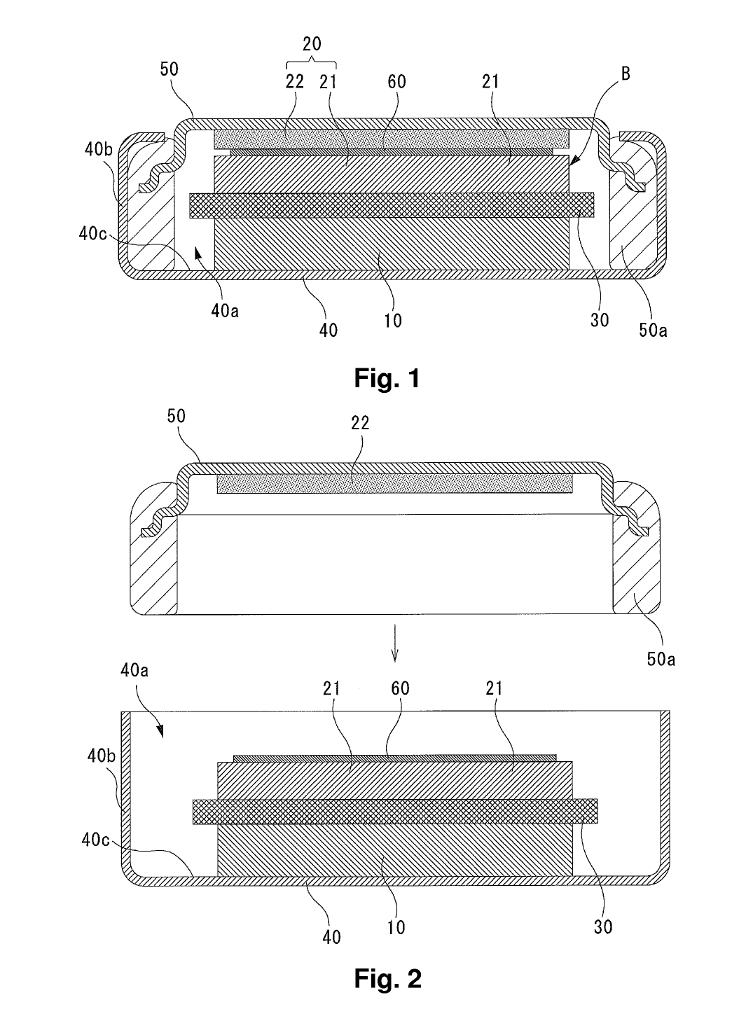

FIGS. 1 to 3 all illustrate a lithium ion capacitor of button or coin type representing one embodiment of the present invention. This lithium ion capacitor comprises: an electricity storage element B formed by a positive electrode 10, a separator 30 and a negative electrode 20 laminated to each other; a case 40 having a concaved section 40a in which to accommodate the electricity storage element B; a ring-shaped gasket 50a contacting an inner periphery of a side wall 40b of the case 40; and a lid 50 that closes the concaved section 40a of the case 40 via the gasket 50a and thereby seals the electricity storage element B and non-aqueous electrolyte in the case 40. The case 40 and lid 50 can be made of any conductive material, such as stainless steel, aluminum, nickel, copper or titanium. The gasket 50a should ideally be made of material offering high electrical insulation property and low permeability of non-aqueous electrolyte and water, such as polypropylene, polystyrene or polyether ether ketone.

The positive electrode 10 contains polyacene (PAS), polyaniline (PAN), active carbon or other active material, as well as polytetrafluoroethylene (PTFE), polyvinylidene difluoride (PVDF), styrene butadiene rubber (SBR) or other binder, where, as necessary, carbon black, graphite, metal powder or other auxiliary conductant is also contained. For the active carbon, any carbide made of coconut husk or other natural material, coke, tar, pitch, graphite or other material made of fossil fuel, or carburized synthetic resin, may be used, among others.

For example, the positive electrode 10 conforming to this embodiment is produced as follows. First, 100 parts by weight of powder, granules, or short fibers of active carbon made of phenol resin are mixed, using a solvent, with 5 parts by weight of carbon black used as auxiliary conductant and 10 parts by weight of PTFE powder used as binder, after which the mixture is rolled and dried into a sheet material. In this embodiment, the thickness of this sheet material is approx. 0.7 mm. Next, a circular sheet of around 20 mm in diameter is punched out from this sheet material to produce the positive electrode 10.

The negative electrode 20 has a first layer 21 containing non-graphitizable carbon material as an active material, and a second layer 22 containing graphite and/or graphitizable carbon material as an active material.

Of all active material constituting the first layer 21, at least 70 percent by weight is polyacene (PAS) or non-graphitizable carbon material. The first layer 21 also contains polytetrafluoroethylene (PTFE), polyvinylidene difluoride (PVDF), styrene butadiene rubber (SBR) or other binder, as well as metal powder or other auxiliary conductant, as necessary. Polyacene or non-graphitizable carbon material accounting for at least 70 percent by weight of all active material constituting the first layer 21 should ideally have a (002) plane spacing of 0.37 nm or more as determined by the X-ray analysis method.

Non-graphitizable carbon material can be obtained by, for example, carburizing the below-mentioned starting material at 300 to 700° C. in flows of inert gas such as nitrogen, followed by heating to 900 to 1500° C. at a rate of 1 to 100° C./minute and then holding the achieved temperature for 0 to 30 hours. The carburizing process can be skipped. For the starting material, furfuryl alcohol resin, furfural resin, furan resin, phenol resin, acrylic resin, halogenated vinyl resin, polyimide resin, polyamide imide resin, polyamide resin, polyacetylene, poly (P-phenylene) or other conjugated resin, or cellulose or its derivative or other organic high-molecular compound may be used. Non-graphitizable carbon material can also be obtained by introducing functional groups containing oxygen into petroleum pitch having a specific H/C atomic ratio, because the resulting material does not melt in the carburization process but undergoes solid state carburization instead. The aforementioned petroleum pitch can be obtained from tar, asphalt, etc., obtained through high-temperature thermal decomposition of coal tar, ethylene bottom oil, crude oil, etc., by means of distillation (vacuum distillation, normal-pressure distillation or steam distillation), thermal polycondensation, extraction, chemical polycondensation or other operation. To obtain non-graphitizable carbon material, it is important to adjust the H/C atomic ratio in petroleum pitch to a range of 0.6 to 0.8.

In this embodiment, the first layer 21 is produced as follows, for example. First, for the active material, 100 parts by weight of powder, granules, or short fibers of non-graphitizable carbon material made of phenol resin are mixed, using a solvent, with 5 parts by weight of metal powder used as auxiliary conductant and 10 parts by weight of PTFE powder used as binder, after which the mixture is rolled and dried into a sheet material. In this embodiment, the thickness of this sheet material is approx. 0.6 mm. Next, a circular sheet of around 20 mm in diameter is punched out from this sheet material to produce the first layer 21. Note that at least 70 percent by weight of all active material constituting the first layer 21 can be polyacene (PAS) or non-graphitizable carbon material, which means that, for the active material, powder, granules, or short fibers of non-graphitizable carbon material made of phenol resin can be combined with powder, granules, or short fibers of natural graphite at a weight ratio of 7 for non-graphitizable carbon material and 3 for natural graphite, for example.

At least 90 percent by weight of all active material constituting the second layer 22 is graphite and/or graphitizable carbon material. The second layer 22 also contains polytetrafluoroethylene (PTFE), polyvinylidene difluoride (PVDF), styrene butadiene rubber (SBR) or other binder, as well as metal powder or other auxiliary conductant, as necessary. Graphite and/or graphitizable carbon material accounting for at least 90 percent by weight of all active material constituting the second layer 22 should ideally have a (002) plane spacing of less than 0.34 nm as determined by the X-ray analysis method. Ideally at least 75 percent by weight of the total weight of the second layer 22 should be accounted for by graphite and/or graphitizable carbon material.

For graphite, natural graphite, artificial graphite, etc., can be used. For artificial graphite, any artificial graphite obtained by carburizing and high-temperature treating organic material, followed by crushing and classification, can be used. High-temperature treatment can be implemented by, for example, carburizing the material at 300 to 700° C. in flows of inert gas such as nitrogen, as necessary, and then raising the temperature to 900 to 1500° C. at a rate of 1 to 100° C. per minute, with the achieved temperature held for 0 to 30 hours or so to achieve calcination, and further heating to 2000° C. or above, or preferably to 2500° C. or above, and holding this temperature for an appropriate period of time. The starting organic material can be coal or pitch. If pitch is used, it can be obtained by distilling, thermal polycondensing, extracting or chemically polycondensing tar, asphalt, etc., obtained from high-temperature thermal decomposition of coal tar, ethylene bottom oil, crude oil, or pitch generated from dry distillation of wood may be used, or polyvinyl chloride resin, polyvinyl acetate, polyvinyl butyrate or 3,5-dimethyl phenol resin may also be used.

Graphitizable carbon material can be obtained, for example, by carburizing the below-mentioned starting material at 300 to 700° C. in flows of inert gas such as nitrogen, followed by heating to 900 to 1500° C. at a rate of 1 to 100° C./minute and then holding the achieved temperature for 0 to 30 hours. The carburizing process can be skipped. Pitch and coal are representative examples of the starting material. Pitch can be obtained by distilling (vacuum distillation, normal-pressure distillation or steam distillation), thermal polycondensing, extracting or chemically polycondensing tar, asphalt, etc., obtained through high-temperature thermal decomposition of coal tar, ethylene bottom oil, crude oil, etc., or pitch generated from dry distillation of wood may be used. Polyvinyl chloride resin, polyvinyl acetate, polyvinyl butyrate or 3,5-dimethyl phenol resin or other high-molecular compound may also be used as the starting material. Other materials that can be used include naphthalene, phenanthrene, anthracene, triphenylene, pyrene, perylene, pentaphene, pentacene and other fused polycyclic hydrocarbon compounds and derivatives thereof (such as carboxylic acid, carboxylic acid anhydrides or carboxylic acid imides thereof) or mixtures thereof, as well as acenaphthylene, indole, isoindole, quinoline, isoquinoline, quinoxaline, phthalazine, carbazole, acridine, phenazine, phenanthridine and other fused heterocyclic compounds and derivatives thereof.

In this embodiment, the second layer 22 is produced as follows, for example. First, for the active material, 100 parts by weight of powder, granules, or short fibers of graphitizable carbon material made of polyvinyl chloride resin are mixed, using a solvent, with 5 parts by weight of metal powder used as auxiliary conductant and 10 parts by weight of PTFE powder used as binder, after which the mixture is rolled and dried into a sheet material. In this embodiment, the thickness of this sheet material is approx. 0.3 mm. Next, a circular sheet of around 20 mm in diameter is punched out from this sheet material to produce the second layer 22. Note that at least 90 percent by weight of all active material constituting the second layer 22 can be graphite and/or graphitizable carbon material, which means that, for the active material, powder, granules, or short fibers of graphitizable carbon material made of polyvinyl chloride resin can be combined with powder, granules or short fibers of natural graphite as well as powder, granules, or short fibers of non-graphitizable carbon material made of phenol resin at a weight ratio of 4 for graphitizable carbon material, 5 for natural graphite and 1 for non-graphitizable carbon material, for example. Ideally the laminated-direction thickness of the electricity storage element B of the second layer 22 should be one-fourth or more, but not more than one time, the laminated-direction thickness of the first layer 21.

The separator 30 can be made of anything as long as it can insulate the positive electrode 10 and negative electrode 20 and allow non-aqueous electrolyte and ions to permeate and transmit through it, such as a porous film, non-woven fabric, fabric structure made of natural cellulose, cellulose derivative, polyolefin, etc. In this embodiment, for example, the separator 30 is porous film made of natural cellulose, formed into a circular sheet of approx. 0.5 mm in thickness and approx. 30 mm in diameter.

In this embodiment, non-aqueous electrolyte is formed by dissolving electrolyte into non-protonic, non-aqueous solvent. This non-aqueous solvent contains one or more of cyclic carbonic acid ester, chained carbonic acid ester, cyclic ester, chained ester, cyclic ether, chained ether, nitriles and sulfur-containing compounds, used alone or as mixed solvent.

Examples of cyclic carbonic acid ester include ethylene carbonate, propylene carbonate, butylene carbonate and vinylene carbonate; examples of chained carbonic acid ester include dimethyl carbonate, ethyl methyl carbonate, diethyl carbonate, methyl propyl carbonate and methyl isopropyl carbonate; examples of cyclic ester include γ-butyrolactone, γ-valerolactone, 3-methyl-γ-butyrolactone and 2-methyl-γ-butyrolactone; examples of chained ester include methyl formate, ethyl formate, methyl acetate, ethyl acetate, propyl acetate, methyl propionate, methyl butyrate and methyl valerate; examples of cyclic ether include 1,4-dioxane, 1,3-dioxolane, tetrahydrofuran, 2-methyl tetrahydrofuran, 3-methyl-1,3-dioxolane and 2-methyl-1,3-dioxolane; examples of chained ether include 1,2-dimethoxy ethane, 1,2-diethoxy ethane, dimethyl 2,5-dioxahexane dioate and dipropyl ether; examples of nitriles include acetonitrile, propanenitrile, glutaronitrile, adiponitrile, methoxy acetonitrile and 3-methoxy propionitrile; and examples of sulfur-containing compounds include sulfolane, dimethyl sulfone, diethyl sulfone, ethyl methyl sulfone, ethyl propyl sulfone and dimethyl sulfoxide. In addition to the aforementioned examples, any other known solvent suitable as non-aqueous solvent for lithium ion capacitor can also be used.

For electrolyte, any electrolyte capable of supplying to non-aqueous electrolyte Li⁺ as electrolytic cationic component and PF₆⁺, BF₄⁻ or other electrolytic anionic component can be used. For example, LiPF₆, LiBF₄, LiAsF₆, LiCLO₄, LiI, etc., can be used. Any known ionic fluid capable of supplying lithium ions as electrolytic cationic component can also be used.

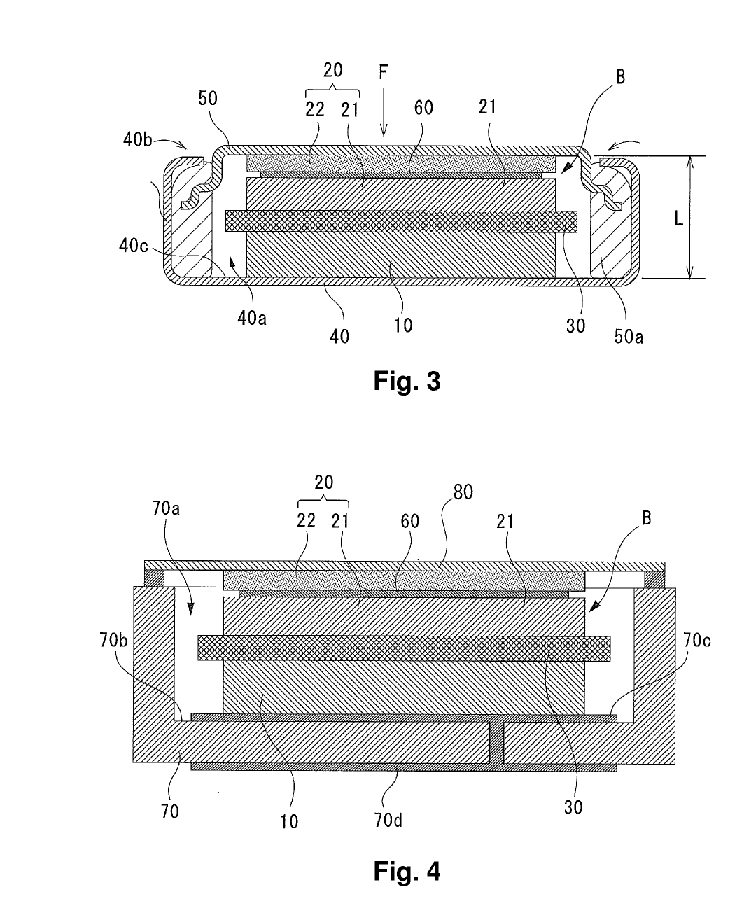

An example of how the electricity storage element B and non-aqueous electrolyte are sealed in the case 40 is explained below. First, as shown in FIG. 2, the positive electrode 10 is placed at the bottom 40c of the concaved section 40a of the case 40, after which the separator 30 is placed on top, the first layer 21 of the negative electrode 20 is placed on top, and the lithium metal sheet 60 is placed on top, while the second layer 22 of the negative electrode 20 is fixed to one side of the lid 50 in the thickness direction using any known conductive adhesive. Here, the lithium metal sheet 60 is formed to have a thickness of approx. 0.1 mm. Generally, the weight of the lithium metal sheet 60 should ideally be around one-fifth to one-tenth the weight of the active materials constituting the first and second layers 21, 22 of the negative electrode 20. Next, non-aqueous electrolyte is filled into the case 40 and the second layer 22 of the lid 50 is placed on the aforementioned lithium metal sheet. Next, as shown in FIG. 3, while applying a downward force F to the lid 50, the top edge of the side wall 40b of the case 40 is clinched inward in the radial direction, thereby closing the concaved section 40a of the case 40 with the lid 50 via the gasket 50a.

At this time, in this embodiment the distance L between the bottom 40c of the concaved section 40a of the case 40 and one side of the lid 50 in the thickness direction is set to approx. 2 mm. On the other hand, the thickness dimension of the electricity storage element B, constituted by the positive electrode 10, separator 30, first layer 21, lithium metal sheet 60 and second layer 22 laminated to each other, should be approx. 2.2 mm as a total sum of the thickness of the positive electrode 10 being approx. 0.7 mm, thickness of the separator 30 being approx. 0.5 mm, thickness of the first layer 21 being approx. 0.6 mm, thickness of the lithium metal sheet being approx. 0.1 mm, and thickness of the second layer 22 being approx. 0.3 mm. However, each component material is compressed slightly in the laminated direction and therefore the laminated-direction dimension of the electricity storage element B is reduced to 2 mm in the case 40.

Once the electricity storage element B and non-aqueous electrolyte are sealed in the concaved section 40a of the case 40 with the lid 50, the first layer 21 and second layer 22 of the negative electrode 20 make electrochemical contact with the lithium metal sheet 60, and lithium ions that have dissolved from the lithium metal sheet 60 into non-aqueous electrolyte are occluded (pre-doped) in the active materials constituting the first layer 21 and second layer 22 before charging. Depending on the size of the lithium metal sheet 60, pre-doping generally takes anywhere from several hours to several tens of days, and in a mass-production process the electricity storage element B and non-aqueous electrolyte are sealed in the case 40 with the lid 50 as explained above and then the sealed case 40 is stored for several hours to several days in a specified storage location.

The lithium metal sheet 60 may dissolve fully in non-aqueous electrolyte due to pre-doping or subsequent charging/discharging, or the sheet may not fully dissolve but partially remain. Even if the lithium metal sheet 60 dissolves fully in non-aqueous electrolyte, the first layer 21 and second layer 22 of the negative electrode 20 may show surface deterioration or discoloration as they have been in contact with the lithium metal sheet 60. In other words, the aforementioned partial material remains, deterioration, discoloration or residues are all evidence that the lithium metal sheet 60 was present.

In the lithium ion capacitor thus constituted, the negative electrode 20 has the first layer 21 and second layer 22, the first layer 21 and second layer 22 are laminated to each other, and the lithium metal sheet 60 is placed between the first layer 21 and second layer 22, and accordingly one side of the lithium metal sheet 60 in the thickness direction contacts the first layer 21, while the other side in the thickness direction contacts the second layer 22. Since lithium in the lithium metal sheet 60 is easily doped by an active material near a contact part, the fact that both sides of the lithium metal sheet 60 in the thickness direction contact an active material allows for efficient pre-doping and consequent improvement of productivity.

Also because the first layer 21 contains non-graphitizable carbon material as an active material, while the second layer 22 contains graphite or graphitizable carbon material as an active material, where the second layer 22 contains at least 90 percent by weight of graphite or graphitizable carbon material relative to all its active material, lithium ions are occluded by the second layer 22 and therefore the thickness dimension of the second layer 22 increases. As mentioned earlier, the electricity storage element B is compressed between the bottom 40c of the case 40 and the lid 50, and specified contact pressures are generated between one side of the electricity storage element B in the laminated direction and the lid 50 and between the other side of the electricity storage element B in the laminated direction and the bottom 40c of the case 40, where these contact pressures increase by the increase in the thickness dimension of the second layer 22. In addition, one side of the electricity storage element B in the laminated direction constitutes the negative layer 20, while the other side of the electricity storage element in the laminated direction constitutes the positive electrode 10, and the lid 50 constitutes one electrode of the lithium ion capacitor, while the case 40 constitutes the other electrode of the lithium ion capacitor, and therefore as the aforementioned contact pressures increase, the internal resistance of the lithium ion capacitor decreases.

Furthermore, the first layer 21 contains non-graphitizable carbon material as an active material, while the second layer contains at least 90 percent by weight of graphite or graphitizable carbon material relative to all its active material. Since non-graphitizable carbon material occludes and releases lithium ions at higher efficiency than graphite or graphitizable carbon material, lithium ions are occluded and released into/from the first layer 21 more than into/from the second layer 22 during charge and discharge. This makes it possible to support higher output and also suppress deterioration caused by repeated occlusion and release of lithium ions into/from the graphite or graphitizable carbon material constituting the second layer 22, which consequently leads to improved cycle characteristics.

Although in this embodiment the positive electrode 10 or negative electrode 20 does not have a collector electrode layer, a collector electrode layer constituted by metal foil may be provided on the bottom 40c surface of the case 40 of the positive electrode 10 or the lid 50 surface of the second layer 22.

Also in this embodiment, a lithium metal sheet different from the lithium metal sheet 60 may be provided in a location different from the lithium metal sheet 60.

Although in this embodiment the second layer 22 fixed to the lid 50 by conductive adhesive is shown, the lid 50 and second layer 22 need not be bonded together.

Also in this embodiment, the second layer 22 provided on the lid 50 side of the negative electrode 20 is shown, but it is possible to provide the first layer 21 on the lid 50 side of the negative electrode 20 and provide the second layer 22 on the positive electrode 10 side. Note that, since graphite or graphitizable material has a smaller plane spacing and thus is more vulnerable to dendrite generation than non-graphitizable carbon material, providing the second layer 22 on the lid 50 side of the negative electrode 20 is more effective in preventing shorting of the positive electrode 10 and negative electrode 20.

Furthermore, in this embodiment the negative electrode 20 provided on the lid 50 side is shown, but it is possible to provide the positive electrode 10 on the lid 50 side and provide the negative electrode 20 on the bottom 40c side of the concaved section 40a of the case 40.

Although in this embodiment one first layer 21 and one second layer 22 are provided in the negative electrode 20, two or more of respective layers 21, 22 can be provided.

Although in this embodiment one layer each of the positive electrode 10, separator 30 and negative electrode 20 are provided, a negative electrode constitution similar to what is explained earlier can still be applied even when two or more layers are provided for 10, and 30, respectively.

In this embodiment a lithium ion capacitor of button or coin type that uses the case 40 having the concaved section 40a, and the lid 50 is shown. Instead, a similar lithium ion capacitor can be formed with a square ceramic case 70 having a concaved section 70a, and a lid 80, as shown in FIG. 4. In this case, the lid 80 is made of Kovar alloy, etc., and an electrode sheet 70c is formed at a bottom 70b of the concaved section 70a of the ceramic case 70, for example, and the electrode sheet 70c is conductive to an external electrode 70d at the bottom of the ceramic case 70. When the lid 80 is fixed to the ceramic case 70 by welding, the electricity storage element B and non-aqueous electrolyte are sealed in the concaved section 70a of the ceramic case 70 with the lid 80.

Although in this embodiment the first layer 21 and second layer 22 are provided in the negative electrode 20 of the lithium ion capacitor, with the lithium metal sheet 60 placed between the layers 21, 22, it is also possible to provide a first layer and second layer in the negative electrode and place a lithium metal sheet between the layers in the same way as in this embodiment, to provide a lithium ion secondary cell whose negative electrode is pre-doped with lithium ions, as this achieves the same effects as in this embodiment. Also with devices other than lithium ion capacitors and lithium ion secondary cells, where the negative electrode is pre-doped with lithium ions, it is also possible to provide a first layer and second layer in the negative electrode and place a lithium metal sheet between the layers, to achieve the same effects as in this embodiment.

In the aforementioned embodiment, a conductive spacer can be provided between the other side of the electricity storage element B in the thickness direction and the bottom 40c of the case 40.

### INDUSTRIAL FIELD OF APPLICATION

The present invention can be widely applied to any electrochemical device comprising: an electricity storage element formed by a positive electrode, a separator and a negative electrode laminated to each other; an electrolyte; a case having a concaved section in which to accommodate the electricity storage element; and a lid that closes the concaved section of the case and thereby seals the electricity storage element and electrolyte in the case, wherein the negative electrode is pre-doped with lithium ions, and application of the present invention achieves effects similar to what were explained above.

The present application claims priority to Japanese Patent Application No. 2010-264216, filed Nov. 26, 2010, the disclosure of which is incorporated herein by reference in its entirety. In this disclosure, “the invention” or “the present invention” may refer to at least one of the embodiments or aspects explicitly, necessarily, or inherently disclosed herein.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. An electrochemical device comprising:
an electricity storage element formed by a positive electrode, a separator and a negative electrode laminated to each other in a specified direction,
a case having a concaved section in which to accommodate the electricity storage element, and
a lid that closes the concaved section of the case and thereby seals the electricity storage element and electrolyte in the case,
wherein one side of the electricity storage element in the laminated direction contacts one side of the lid in the thickness direction;
wherein the negative electrode has a first layer containing non-graphitizable carbon material as an active material, and a second layer containing graphite and/or graphitizable carbon material as an active material,
wherein the second layer contains at least 90 percent by weight of graphite or graphitizable carbon material relative to all its active material, and
wherein the first layer and second layer are laminated to each other in the specified direction with a lithium metal sheet placed in between.

2. An electrochemical device comprising:
an electricity storage element formed by a positive electrode, a separator and a negative electrode laminated to each other in a specified direction,
a case having a concaved section in which to accommodate the electricity storage element, and
a lid that closes the concaved section of the case and thereby seals the electricity storage element and electrolyte in the case,
wherein one side of the electricity storage element in the laminated direction contacts one side of the lid in the thickness direction, and the other side of the electricity storage element in the laminated direction contacts the bottom of the concaved section of the case;
wherein the negative electrode has a first layer containing non-graphitizable carbon material as an active material, and a second layer containing graphite and/or graphitizable carbon material as an active material,
wherein the second layer contains at least 90 percent by weight of graphite or graphitizable carbon material relative to all its active material,
wherein the first layer and second layer are laminated to each other in the specified direction, and
wherein there is evidence of presence of a lithium metal sheet between the first layer and second layer.

3. An electrochemical device according to claim 1, wherein the laminated-direction thickness of the second layer is one-fourth or more, but not more than one time, the laminated-direction thickness of the first layer.

4. An electrochemical device according to claim 2, wherein the laminated-direction thickness of the second layer is one-fourth or more, but not more than one time, the laminated-direction thickness of the first layer.

5. An electrochemical device comprising:
an electricity storage element having a positive electrode and a negative electrode laminated together with a separator placed in between and in contact with the positive and negative electrodes,
a case having a concaved section in which to accommodate the electricity storage element, wherein one of the positive or negative electrode is attached to a bottom of the concaved section,
an electrolyte in contact with the positive and negative electrode in the case; and
a lid that closes the concaved section of the case and thereby seals the electricity storage element and electrolyte in the case, wherein the other of the positive or negative electrode is attached to an inner surface of the lid,
wherein the negative electrode is constituted by first and second layers extending in a direction perpendicular to the laminated direction of the electricity storage element, said first layer being closer to the separator than is the second layer, said first layer containing non-graphitizable carbon material as a main active material, said second layer containing graphite and/or graphitizable carbon material as a main active material, and
wherein the first and second layers are laminated to each other, between which a lithium metal sheet is placed and in contact with the first and second layers, or a trace of the lithium metal sheet which has been dissolved is present.

6. An electrochemical device according to claim 5, wherein the first layer contains at least 70 percent by weight of non-graphitizable carbon material relative to all active materials of the first layer, and the second layer contains at least 90 percent by weight of graphite and/or graphitizable carbon material relative to all active materials of the second layer.

7. An electrochemical device according to claim 5, wherein more lithium ions are occluded by the second layer than by the first layer.

8. An electrochemical device according to claim 5, wherein the laminated-direction thickness of the second layer is one-fourth or more, but not more than one time, the laminated-direction thickness of the first layer.
